(19) United States
(12) Patent Application Publication
(10) Pub. No.: US 2021/0065333 A1
(43) Pub. Date: Mar. 4, 2021

(54) IMAGE PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Masakazu OGAWA, Kanagawa (JP)

(73) Assignee: FUJI XEROX CO., LTD., Tokyo (JP)

(21) Appl. No.: 16/829,161

(22) Filed: Mar. 25, 2020

(30) Foreign Application Priority Data
Sep. 3, 2019 (JP) 2019-160136

(51) Int. Cl. G06T 3/00; G06T 7/73; G06T 7/50

(52) U.S. Cl. CPC G06T 3/0093; G06T 7/50; G06T 7/73; G06T 3/0012

(57) ABSTRACT

An image processing apparatus includes a position specifier that specifies a position in a pre-conversion image, a storage that stores the specified position in the pre-conversion image in association with additional information, a converter that performs coordinate conversion for the pre-conversion image to obtain a post-conversion image in a different coordinate system, and performs coordinate conversion for the specified position in the pre-conversion image to obtain a post-conversion position in the different coordinate system, and a display controller that displays the additional information at the post-conversion position serving as a reference position in the post-conversion image.

### CROSS-REFERENCE TO RELATED APPLICATIONS

This application is based on and claims priority under 35 USC 119 from Japanese Patent Application No. 2019-160136 filed Sep. 3, 2019.

### BACKGROUND

### (i) Technical Field

The present disclosure relates to an image processing apparatus and a non-transitory computer readable medium storing a program.

### (ii) Related Art

Japanese Unexamined Patent Application Publication No. 2014-50066 discloses an image output service terminal that receives a user's instruction to print image data and then prints the image data with texts or decorations combined as the user likes. The image output service terminal provides a function of inputting the same text into a plurality of images at a time. In this function, the text and each image are combined so that the text fits in the image and keeps its position away from the center of the image based on the aspect ratio of the selected image and the aspect ratios of the other images.

### SUMMARY

Aspects of non-limiting embodiments of the present disclosure relate to an image processing apparatus and a non-transitory computer readable medium storing a program, in which an image with additional information is converted into an image in a different coordinate system and the post-conversion image is displayed so that the additional information keeps its original display settings.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing apparatus comprising a position specifier that specifies a position in a pre-conversion image, a storage that stores the specified position in the pre-conversion image in association with additional information, a converter that performs coordinate conversion for the pre-conversion image to obtain a post-conversion image in a different coordinate system, and performs coordinate conversion for the specified position in the pre-conversion image to obtain a post-conversion position in the different coordinate system, and a display controller that displays the additional information at the post-conversion position serving as a reference position in the post-conversion image.

### BRIEF DESCRIPTION OF THE DRAWINGS

An exemplary embodiment of the present disclosure will be described in detail based on the following figures, wherein:

FIG. 1 illustrates the hardware configuration of an image processing apparatus according to an exemplary embodiment of the present disclosure;

FIG. 2 illustrates functional blocks of the image processing apparatus of FIG. 1;

FIG. 3 illustrates an overview of a process of performing coordinate conversion for a pre-conversion image to obtain a post-conversion image in a different coordinate system;

FIG. 4 is a flowchart illustrating a flow of a process of adding additional information to a pre-conversion image in the image processing apparatus according to the exemplary embodiment;

FIG. 5 illustrates an example of the pre-conversion image with additional information;

FIG. 6 is a flowchart illustrating a flow of a process of performing coordinate conversion for a pre-conversion image with additional information;

FIG. 7 illustrates an example of the pre-conversion image with additional information and a post-conversion image with additional information;

FIG. 8 is a flowchart illustrating a flow of a process of performing coordinate conversion for a pre-conversion image with additional information and displaying a post-conversion image cropped in part;

FIG. 9 illustrates an example of the case where the pre-conversion image with additional information is subjected to coordinate conversion and a post-conversion image is displayed while being cropped in part;

FIG. 10 illustrates an image turned counterclockwise by 45° in a fixed frame, and a cropped and turned image displayed on a display; and

FIG. 11 illustrates a cropped image to be zoomed in or out, and resultant images displayed on the display.

### DETAILED DESCRIPTION

### [Image Processing Apparatus]

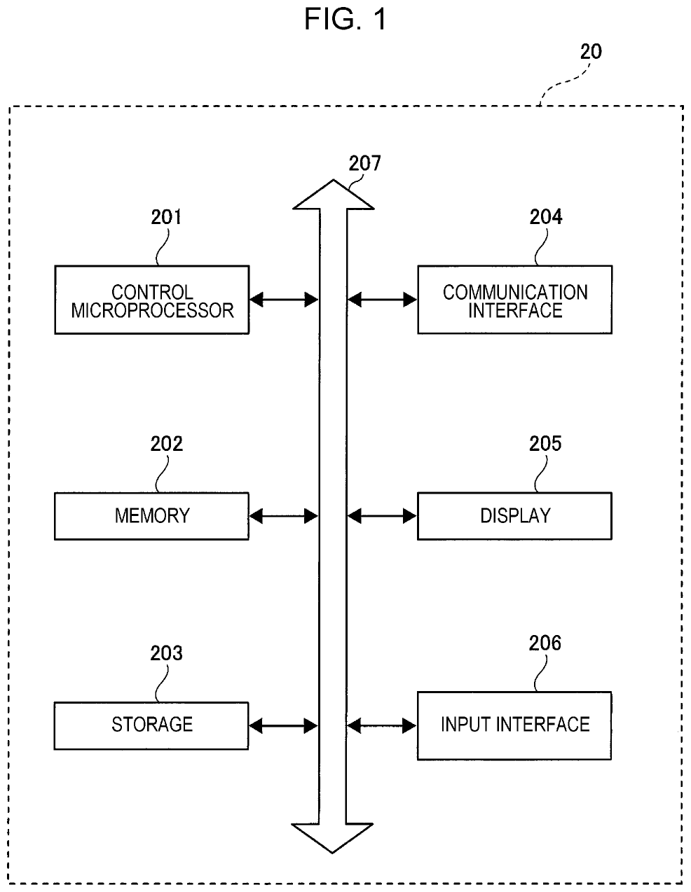

An image processing apparatus 20 according to an exemplary embodiment of the present disclosure is described with reference to FIG. 1. FIG. 1 illustrates the hardware configuration of the image processing apparatus 20 according to this exemplary embodiment. For example, the image processing apparatus 20 is a desktop computer but may be a notebook computer, a tablet computer, or other terminal apparatuses as long as the image processing apparatus 20 has the following configuration.

As illustrated in FIG. 1, the image processing apparatus 20 includes a control microprocessor 201, a memory 202, a storage 203, a communication interface 204, a display 205, and an input interface 206, which are connected to a control bus 207.

The control microprocessor 201 controls operations of the components of the image processing apparatus 20 based on a control program stored in the storage 203.

The memory 202 temporarily stores post-conversion image data and additional information added to the post-conversion image data. The post-conversion image data is obtained by converting image data stored in the storage 203 into image data in a different coordinate system.

The storage 203 is a hard disk drive (HDD) or a solid-state drive (SDD) that stores the control program for controlling the components of the image processing apparatus 20. The storage 203 also stores image data obtained by a 360-degree camera (not illustrated), and additional information added to the image data.

The communication interface 204 controls communications between the image processing apparatus 20 and the 360-degree camera or an image storage server so that the image processing apparatus 20 acquires images from the 360-degree camera or the image storage server.

The display 205 is a liquid crystal display provided integrally with or separately from the image processing apparatus 20 to display information processed by a display controller described later.

The input interface 206 includes a keyboard and a mouse to serve as an inputter to be used by a user of the image processing apparatus 20 to input an image data conversion instruction or additional information as described later.

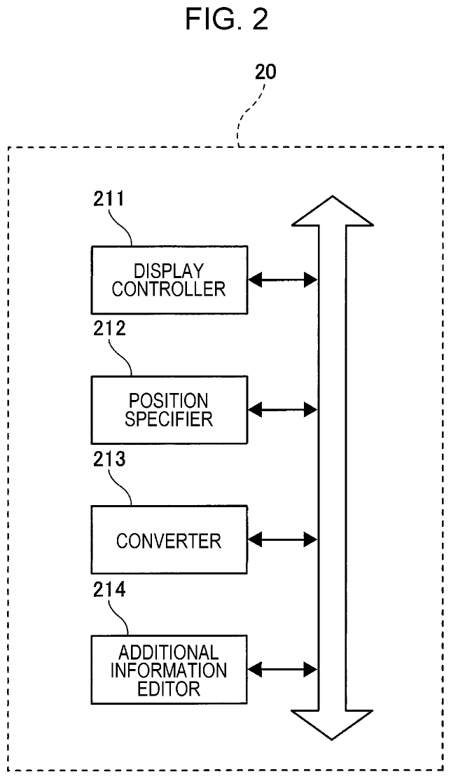

Next, functions of the image processing apparatus 20 according to this exemplary embodiment are described with reference to FIG. 2. FIG. 2 illustrates functional blocks of the image processing apparatus 20 of FIG. 1. As illustrated in FIG. 2, the image processing apparatus 20 implements functions of a display controller 211, a position specifier 212, a converter 213, and an additional information editor 214 by causing the control microprocessor 201 to execute the control program stored in the storage 203.

In response to a user's instruction via the input interface 206, the display controller 211 controls the display 205 to display a pre-conversion image stored in the storage 203. In response to the additional information editor 214 adding any additional information to the pre-conversion image, the display controller 211 lays, on the display 205, the additional information over the pre-conversion image at a reference position specified by the position specifier 212. In response to the converter 213 converting the pre-conversion image into an image in a different coordinate system, the display controller 211 displays the post-conversion image on the display 205 and lays the additional information added by the additional information editor 214 over the post-conversion image at a post-conversion reference position.

While a pre-conversion image is being displayed on the display 205, the user may operate the input interface 206 to specify a reference position where additional information will be added. In response to this operation, the position specifier 212 acquires positional information of the reference position in the pre-conversion image. In addition, the position specifier 212 acquires information on a relative position of the additional information with respect to the reference position.

In response to a user's instruction via the input interface 206, the converter 213 performs coordinate conversion for a pre-conversion image stored in the storage 203 to obtain a post-conversion image in a different coordinate system, and stores the post-conversion image in the memory 202. Further, the converter 213 performs coordinate conversion for a reference position of additional information specified by the position specifier 212 in the pre-conversion image to obtain a post-conversion reference position in the different coordinate system, and stores the post-conversion reference position in the memory 202.

While a pre-conversion image is being displayed on the display 205, the user may operate the input interface 206 to input additional information. In response to this operation, the additional information editor 214 stores the additional information in the storage 203 in association with information on a reference position and a relative position specified by the position specifier 212.

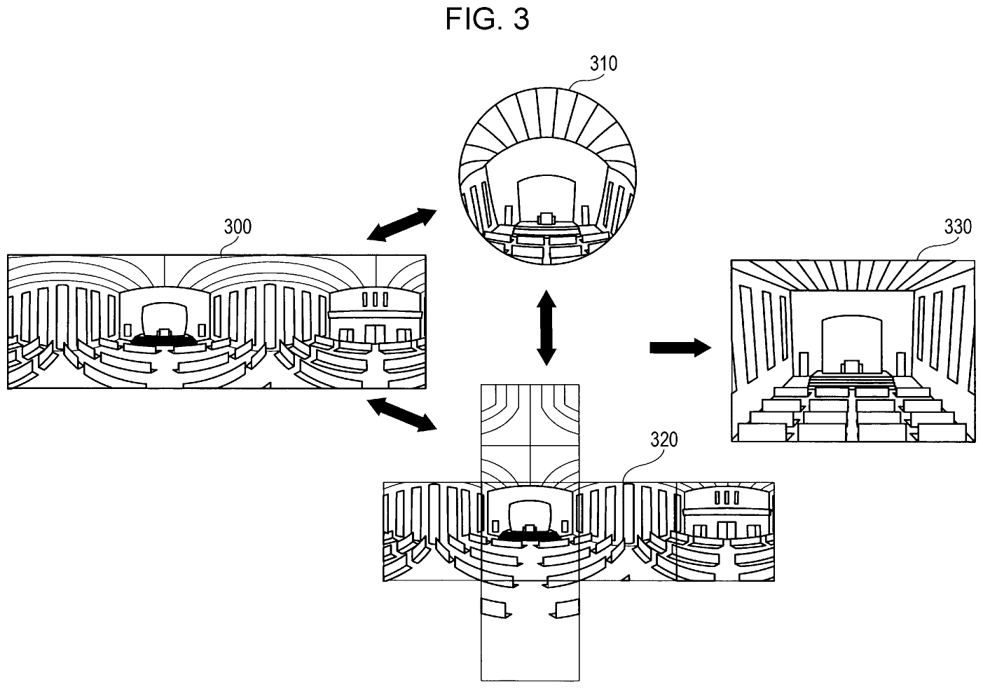

Referring to FIG. 3, description is made of an overview of a process of performing, by the converter 213, coordinate conversion for a pre-conversion image to obtain a post-conversion image in a different coordinate system in the image processing apparatus 20 of this exemplary embodiment. FIG. 3 illustrates the overview of the process of performing coordinate conversion for a pre-conversion image to obtain a post-conversion image in a different coordinate system. An image acquired from the 360-degree camera or the image storage server via the communication interface 204 is stored in the storage 203 as equirectangular image data 300. In response to a user's instruction, the converter 213 performs coordinate conversion for the equirectangular image data 300 to obtain domemaster image data 310 or cubemap image data 320, and temporarily stores the post-conversion image data in the memory 202. The post-conversion image data may be stored in the storage 203.

The pieces of image data in the formats described above are convertible reversibly or mutually. The domemaster image data 310 or the cubemap image data 320 may be subjected to coordinate conversion to obtain the equirectangular image data 300. The domemaster image data 310 may be subjected to coordinate conversion to obtain the cubemap image data 320, and vice versa. The pre-conversion image data may be the domemaster image data 310 or the cubemap image data 320, and the post-conversion image data may be the equirectangular image data 300.

The image processing apparatus 20 of this exemplary embodiment may crop, that is, cut out a part of a pre-conversion equirectangular image or a post-conversion domemaster or cubemap image and display the resultant image on the display 205 as a cropped image 330. In this case as well, the converter 213 performs coordinate conversion for an image cut out in a display target area or an image in a specified area without simply displaying a cut-out part of the equirectangular, domemaster, or cubemap image on the display 205. Then, the converter 213 temporarily stores the post-conversion image in the memory 202 and the display controller 211 displays the image on the display 205.

### <<Processes>>

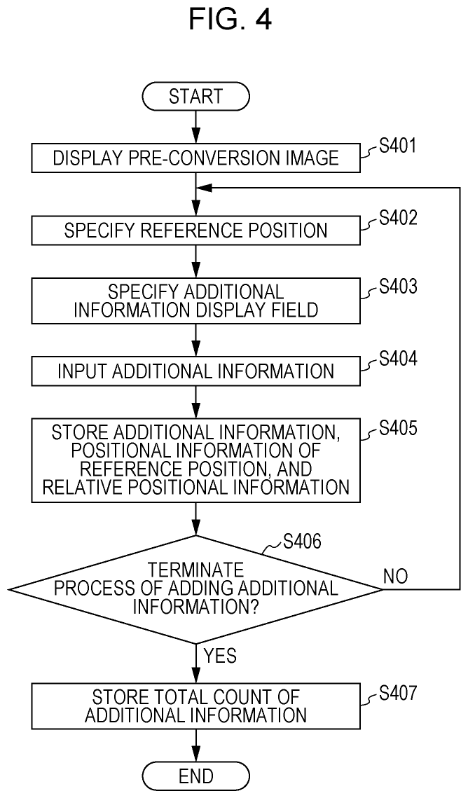

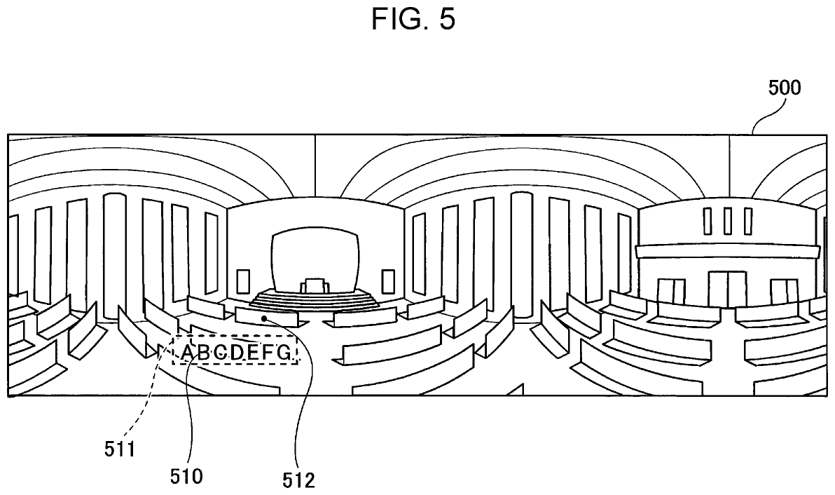

Referring to FIG. 4 and FIG. 5, description is made of a process of adding additional information to a pre-conversion image in the image processing apparatus 20 of this exemplary embodiment. FIG. 4 is a flowchart illustrating a flow of the process of adding additional information to a pre-conversion image in the image processing apparatus 20 according to this exemplary embodiment. FIG. 5 illustrates an example of the pre-conversion image with additional information.

In Step S401 of FIG. 4, the display controller 211 displays a pre-conversion image, that is, an equirectangular image stored in the storage 203 on the display 205 in response to a user's instruction via the input interface 206.

In Step S402, the additional information editor 214 receives a user's operation for adding additional information via the input interface 206. When the user specifies a reference position of the additional information in the pre-conversion image, the position specifier 212 acquires positional information of the reference position in the pre-conversion image and temporarily stores the positional information in the memory 202.

In Step S403, the additional information editor 214 receives an operation of specifying a field where the additional information will be displayed actually (hereinafter referred to as “additional information display field”). When the user specifies the additional information display field in the pre-conversion image, the position specifier 212 acquires positional information of the additional information display field in the pre-conversion image and temporarily stores the positional information in the memory 202. The reference position may overlap the additional information display field or may be specified away from the additional information display field. The positional information of the additional information display field may be an area, or a point such as “top left” or “center of gravity”.

In Step S404, the additional information editor 214 receives an operation of inputting the additional information. The additional information, as typified by a text, symbol, shape, or icon, is an additional element to be laid over the pre-conversion image by the user as appropriate later on. If the additional information is a text, the user inputs text data via the input interface 206. If the additional information is a shape, the additional information editor 214 causes the display 205 to display a list of insertable shapes, the user selects any shape from the list, and the display 205 displays the shape in the additional information display field.

For example, FIG. 5 illustrates a pre-conversion equirectangular image 500 overlaid with a text 510. The text 510 is displayed in an additional information display field 511. The additional information display field 511 is associated with a reference position 512 of the additional information. The reference position 512 of the additional information may be specified in the additional information display field 511, or may be specified outside the additional information display field 511 as illustrated in FIG. 5.

In Step S405, the additional information editor 214 stores the additional information, the positional information of the reference position of the additional information, and the relative positional information of the additional information display field with respect to the reference position in the storage 203 in association with each other. The relative positional information indicates a relative position of the center of gravity of the additional information display field with respect to the reference position. The relative positional information is represented by a distance and an angle between the reference position and the center of gravity of the additional information display field. The relative positional information is not limited to the information indicating the relative position of the center of gravity of the additional information display field with respect to the reference position, but may be information indicating a relative position of a point specified as the additional information display field, such as “top left” or “bottom right”.

In Step S406, the additional information editor 214 inquires of the user whether to terminate the process of adding the additional information to the pre-conversion image. If the user instructs the additional information editor 214 to terminate the process, the additional information editor 214 stores, in Step S407, the total count of the additional information added to the pre-conversion image in the storage 203 in association with the image data. Then, the additional information editor 214 terminates the process. If the user decides not to terminate the process of adding the additional information to the pre-conversion image, the additional information editor 214 returns to Step S402 and repeats the processes of Step S402 to Step S405 until the user decides to terminate the process of adding the additional information.

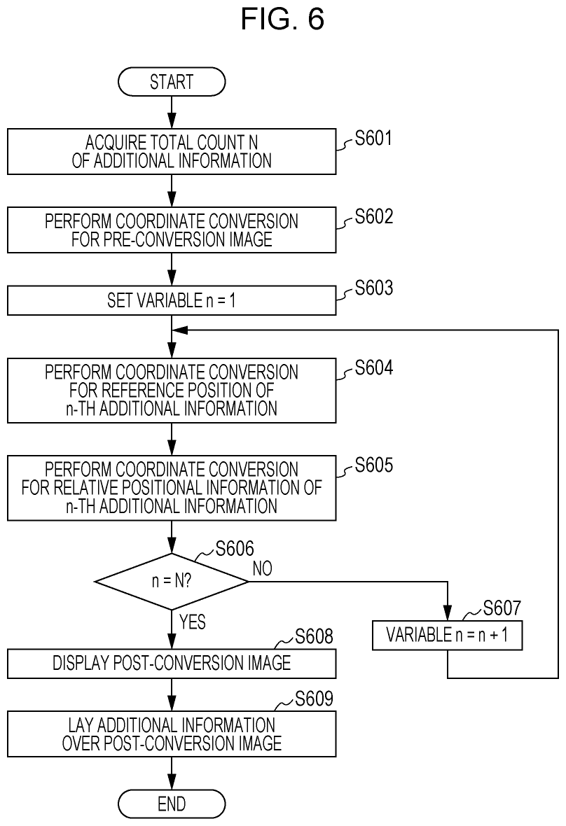

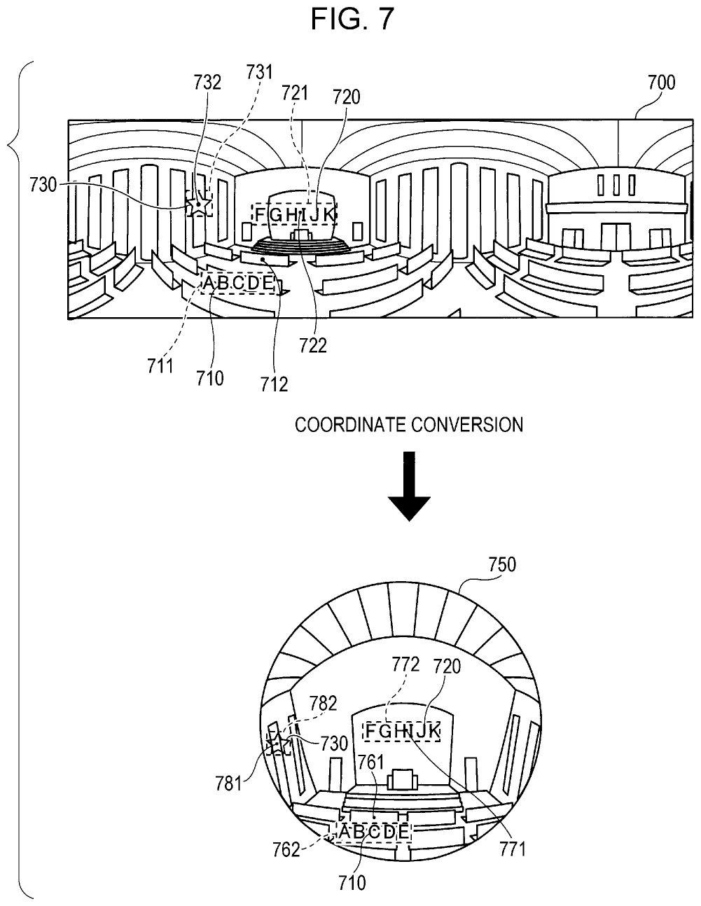

Referring to FIG. 6 and FIG. 7, description is made of a process of performing coordinate conversion for a pre-conversion image with additional information. FIG. 6 is a flowchart illustrating a flow of the process of performing coordinate conversion for a pre-conversion image with additional information. FIG. 7 illustrates an example of the pre-conversion image with additional information and a post-conversion image with additional information.

In Step S601, the converter 213 acquires, from the storage 203, a total count N of additional information stored in association with a pre-conversion image to be subjected to coordinate conversion. In the image illustrated in FIG. 7, the total count N of the additional information is “3”.

In Step S602, the converter 213 performs coordinate conversion for the pre-conversion image stored in the storage 203 and stores a post-conversion image in the memory 202 or the storage 203. In the conversion process illustrated in FIG. 7, the converter 213 performs coordinate conversion for a pre-conversion equirectangular image 700 to obtain a domemaster image 750, and stores the post-conversion image in the memory 202 or the storage 203.

In Step S603, the converter 213 sets a variable n to “1”. The variable n is used when the converter 213 performs coordinate conversion for positional information of each piece of additional information associated with the pre-conversion image.

In Step S604, the converter 213 acquires positional information of a reference position of n-th additional information associated with the pre-conversion image. For example, the converter 213 acquires positional information of a reference position 712 in FIG. 7. The converter 213 performs coordinate conversion for the positional information and stores, in the memory 202, a reference position of the additional information in the post-conversion image.

In Step S605, the converter 213 performs coordinate conversion for relative positional information of an additional information display field with respect to the reference position in the n-th additional information associated with the pre-conversion image. The converter 213 stores a result of the coordinate conversion in the memory 202.

In Step S606, the converter 213 determines whether the variable n is equal to the total count N of the additional information stored in association with the pre-conversion image. If the converter 213 determines that the variable n is not equal to the total count N of the additional information, the converter 213 proceeds to Step S607. The converter 213 adds “1” to the variable n and returns to Step S604. The converter 213 repeats the processes of Steps S604 to S606 for the remaining pieces of additional information associated with the pre-conversion image.

If the converter 213 determines in Step S606 that the variable n is equal to the total count N of the additional information, the display controller 211 causes, in Step S608, the display 205 to display the post-conversion image stored in the memory 202 or the storage 203.

In Step S609, the display controller 211 lays the additional information stored in the memory 202 over the post-conversion image displayed on the display 205 at a position indicated by the post-conversion relative positional information with respect to the post-conversion reference position. Then, the display controller 211 terminates the process.

For example, FIG. 7 illustrates three pieces of additional information 710, 720, and 730 added to the pre-conversion equirectangular image 700. The pieces of additional information 710 and 720 are texts, which are displayed in additional information display fields 711 and 721, respectively. The additional information 730 is a shape, which is displayed in an additional information display field 731. The reference position 712 of the additional information 710 is specified outside the additional information display field 711. Reference positions 722 and 732 of the pieces of additional information 720 and 730 are specified in the additional information display fields 721 and 731, respectively.

When the converter 213 converts the pre-conversion image 700 into the domemaster image 750, the pieces of additional information 710, 720, and 730 in the pre-conversion image 700 are laid over the post-conversion image 750 in additional information display fields 762, 772, and 782 indicated by pieces of relative positional information obtained by the converter 213 through coordinate conversion with respect to reference positions 761, 771, and 781 obtained by the converter 213 through coordinate conversion, respectively.

As illustrated in FIG. 7, the additional information display field 762 of the additional information 710 is located away from the reference position 761 obtained through coordinate conversion. The additional information display fields 772 and 782 of the pieces of additional information 720 and 730 overlap the reference positions 771 and 781 obtained through coordinate conversion, respectively. Compared with the pieces of additional information 710, 720, and 730 before coordinate conversion, the pieces of additional information 710, 720, and 730 after coordinate conversion are laid over the domemaster image 750 so that the pieces of additional information 710, 720, and 730 keep their original display settings such as inclination, vertical orientation, size, and form in FIG. 7.

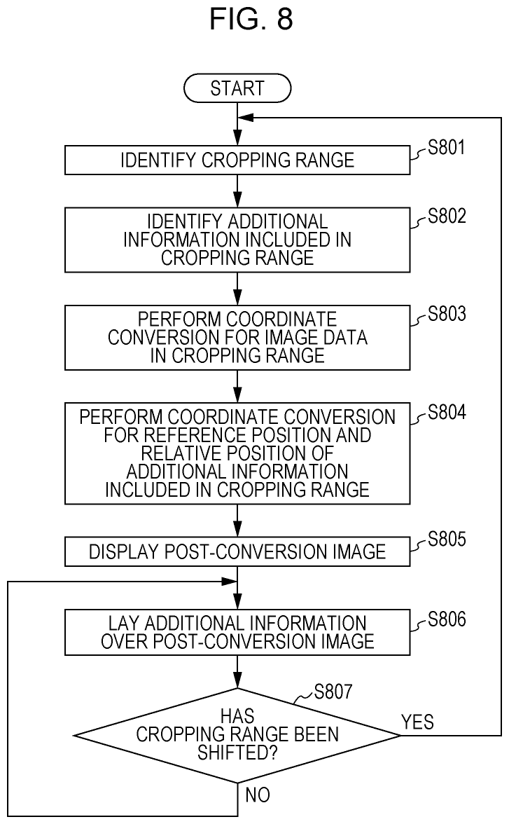

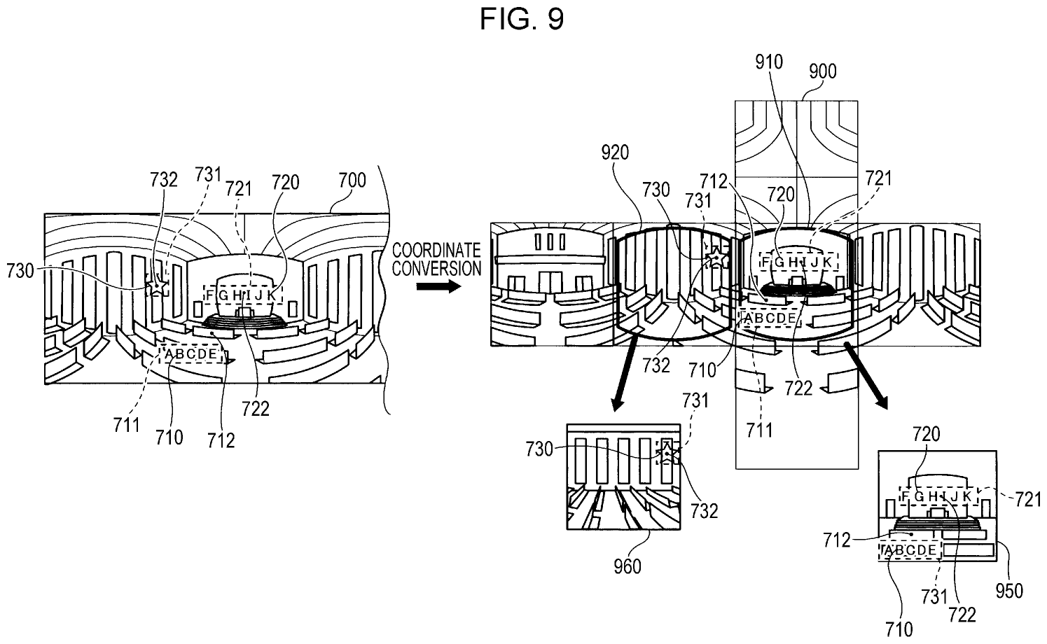

Referring to FIG. 8 and FIG. 9, description is made of a process of performing coordinate conversion for a pre-conversion image with additional information and displaying a post-conversion image cropped, that is, cut out in part. FIG. 8 is a flowchart illustrating a flow of the process of performing coordinate conversion for a pre-conversion image with additional information and displaying a post-conversion image cropped in part. FIG. 9 illustrates an example of the case where the pre-conversion image with additional information is subjected to coordinate conversion and a post-conversion image is displayed while being cropped in part. In the example illustrated in FIG. 8 and FIG. 9, the equirectangular image 700 is temporarily converted into a cubemap image and then the cubemap image is displayed on the display 205 while being cropped in part.

FIG. 9 illustrates a method for performing coordinate conversion for the equirectangular image 700 with additional information to obtain a cubemap image 900. The method is substantially the same as the processes of Step S601 to Step S606 of FIG. 6 and description thereof is omitted.

In Step S801, the position specifier 212 identifies a cropping range in the cubemap image 900 obtained by performing coordinate conversion for the equirectangular image 700. Specifically, the position specifier 212 determines a point of sight and an angle based on a user's input operation via the input interface 206, and identifies a cropping range based on the point of sight and the angle.

In Step S802, the converter 213 identifies additional information included in the cropping range of the pre-conversion image.

In Step S803, the converter 213 performs coordinate conversion for the image in the cropping range of the pre-conversion image to generate a post-conversion image, and stores the post-conversion image in the memory 202.

In Step S804, the converter 213 performs coordinate conversion for a reference position and a relative position of the additional information included in the cropping range, which is identified in Step S802. The converter 213 stores a result of the coordinate conversion in the memory 202.

In Step S805, the display controller 211 causes the display 205 to display the post-conversion image in the cropping range, which is stored in the memory 202.

In Step S806, the display controller 211 lays the identified additional information included in the cropping range over the post-conversion image displayed on the display 205 based on the positional information of the post-conversion reference position and the post-conversion relative positional information, which are stored in the memory 202.

In Step S807, the position specifier 212 determines whether the cropping range is shifted based on a user's input operation via the input interface 206. If the position specifier 212 determines that the cropping range is shifted, the position specifier 212 returns to Step S801. The processes of Step S801 to Step S806 are repeated so that the display 205 displays an image and additional information that are included in the new cropping range.

If the position specifier 212 determines in Step S807 that the cropping range is not shifted, the display controller 211 causes the display 205 to keep displaying the image in Step S806.

In the example illustrated in FIG. 9, a part of the cubemap image 900 is specified as a cropping range 910. The pieces of additional information 710 and 720 are included in the cropping range. Therefore, the pieces of additional information 710 and 720 are displayed in a cropped image 950 on the display 205. If the cropping range is shifted to a range 920, the additional information 730 is included in the range 920. Therefore, the additional information 730 is displayed in a cropped image 960 on the display 205.

Compared with the additional information before cropping, the additional information after cropping is laid over the cropped image 950 or 960 so that the additional information keeps its original display settings such as inclination, vertical orientation, size, and form.

In the example illustrated in FIG. 9, the cropping range is shifted in a horizontal direction based on a given point of sight. In other words, the cropping range, that is, a so-called “frame” at a given point of sight is fixed and the image in the frame is shifted in the horizontal direction. The image in the cropping range, that is, in the frame is displayed with its distortion controlled through coordinate conversion. The image in the fixed frame may be shifted in a vertical or oblique direction or turned about a given point in the image.

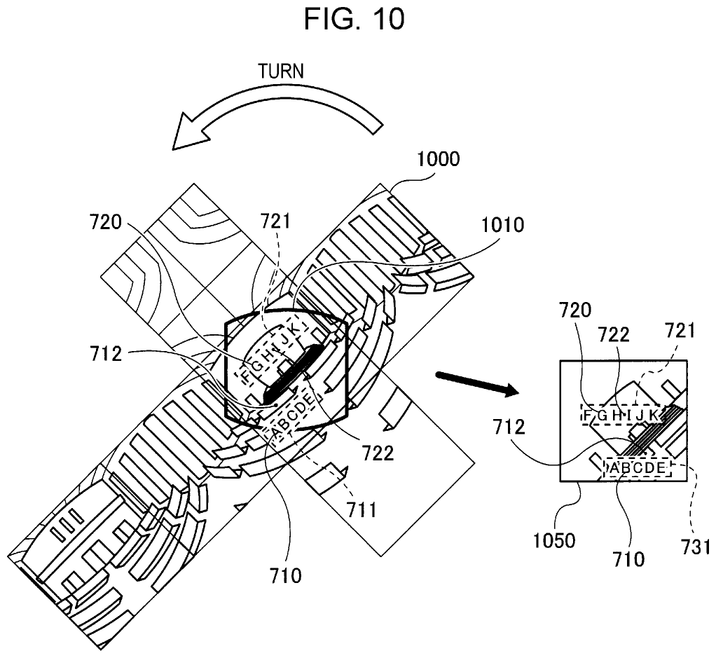

For example, FIG. 10 illustrates an image 1000 turned counterclockwise by 45° in a fixed frame 1010. In this case, the pieces of additional information 710 and 720 are displayed in a cropped and turned image 1050. The pieces of additional information 710 and 720 are laid over the cropped and turned image 1050 so that the pieces of additional information 710 and 720 keep their original display settings such as inclination, vertical orientation, size, and form though the image has been turned.

In the image to be processed in the exemplary embodiment of the present disclosure, depth information may be stored in association with each point or element in the image. The depth information may be stored in association with each pixel or each set of coordinates in the image stored in the storage 203, or the user may add the depth information later in association with each point in the image specified by the position specifier 212.

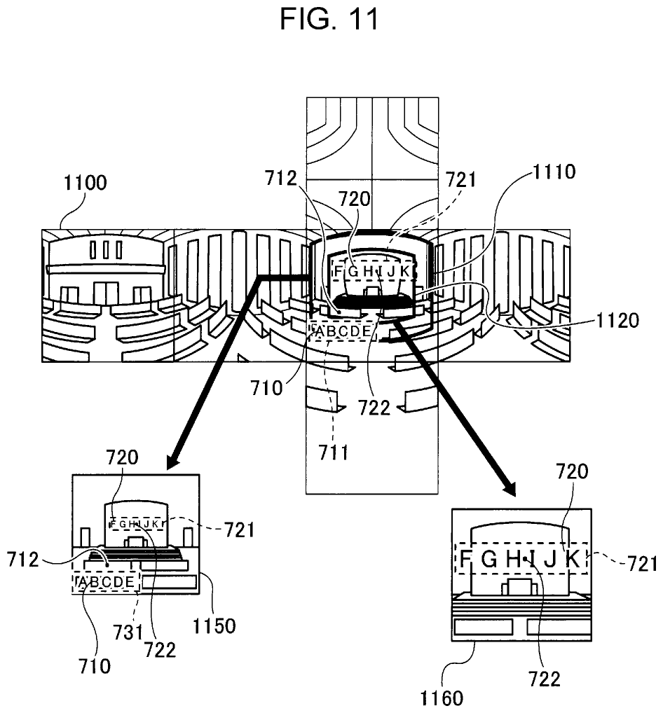

For example, as illustrated in FIG. 11, the user operates the input interface 206 to zoom in or out a cropped image 1150 or 1160. Then, the size of a frame 1110 or 1120 is reduced or increased. For example, the pieces of additional information 710 and 720 are included in the image 1150 in the frame 1110. Depth information indicating a near side as a depth is associated with coordinates of the reference position 712 of the additional information 710. Depth information indicating a far side as a depth is associated with coordinates of the reference position 722 of the additional information 720. The depth information may be information indicating a distance from a point of sight to each element or reference position in the image obtained by the 360-degree camera.

The additional information 710 is located on a near side compared with the additional information 720. Therefore, the additional information display field 711 of the additional information 710 in FIG. 11 is larger than the additional information display field 721 of the additional information 720. The additional information 720 is located on a far side compared with the additional information 710. Therefore, the additional information display field 721 of the additional information 720 in FIG. 11 is smaller than the additional information display field 711 of the additional information 710.

When the user operates the input interface 206 to zoom in the image 1150 in the frame 1110, the size of the frame in an image 1100 is reduced and the image 1160 in the frame 1120 is displayed. In this case, the reference position 722 of the additional information 720 appears to become closer to the point of sight. The converter 213 changes the depth information of the reference position 722 of the additional information 720 based on the distance from the point of sight. The display controller 211 increases the size of the additional information display field 721 based on the changed depth information and lays the additional information display field 721 over the switched image 1160.

When the image is zoomed out, the additional information appears to become away from the point of sight. Therefore, the display controller 211 reduces the size of the additional information display field based on the depth information of the reference position changed by the converter 213, and lays the additional information display field over the switched image. The size of the additional information display field 721 may be increased or reduced without changing the depth information. In this case, the distance from the point of sight to the reference position is calculated based on the depth information and the size of the additional information display field 721 is changed based on the distance.

In the exemplary embodiment described above, the equirectangular image is stored in the storage 203 and is cropped, turned, increased or reduced in size, or subjected to coordinate conversion into an image in a different format. The image before coordinate conversion may be an image in a format other than the equirectangular format.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image processing apparatus comprising:
a position specifier that specifies a position in a pre-conversion image;
a storage that stores the specified position in the pre-conversion image in association with additional information;
a converter that performs coordinate conversion for the pre-conversion image to obtain a post-conversion image in a different coordinate system, and performs coordinate conversion for the specified position in the pre-conversion image to obtain a post-conversion position in the different coordinate system; and
a display controller that displays the additional information at the post-conversion position serving as a reference position in the post-conversion image.

2. The image processing apparatus according to claim 1, wherein the display controller displays the additional information in the post-conversion image so that the additional information keeps display settings in the pre-conversion image.

3. The image processing apparatus according to claim 2, wherein the display controller displays the additional information in the post-conversion image so that the additional information keeps inclination in the pre-conversion image.

4. The image processing apparatus according to claim 2, wherein the display controller displays the additional information in the post-conversion image so that the additional information keeps vertical orientation in the pre-conversion image.

5. The image processing apparatus according to claim 2, wherein the display controller displays a partial area in the post-conversion image as a display target area, and displays, when the displayed post-conversion image is shifted by a shift of the display target area, the additional information so that the additional information keeps the display settings in the pre-conversion image.

6. The image processing apparatus according to claim 3, wherein the display controller displays a partial area in the post-conversion image as a display target area, and displays, when the displayed post-conversion image is shifted by a shift of the display target area, the additional information so that the additional information keeps the display settings in the pre-conversion image.

7. The image processing apparatus according to claim 4, wherein the display controller displays a partial area in the post-conversion image as a display target area, and displays, if the displayed post-conversion image is shifted by a shift of the display target area, the additional information so that the additional information keeps the display settings in the pre-conversion image.

8. The image processing apparatus according to claim 2, wherein the display controller displays, if the post-conversion image is displayed with a turn, the additional information so that the additional information keeps the display settings in the pre-conversion image.

9. The image processing apparatus according to claim 3, wherein the display controller displays, if the post-conversion image is displayed with a turn, the additional information so that the additional information keeps the display settings in the pre-conversion image.

10. The image processing apparatus according to claim 4, wherein the display controller displays, if the post-conversion image is displayed with a turn, the additional information so that the additional information keeps the display settings in the pre-conversion image.

11. The image processing apparatus according to claim 5, wherein the display controller displays, if the post-conversion image is displayed with a turn, the additional information so that the additional information keeps the display settings in the pre-conversion image.

12. The image processing apparatus according to claim 6, wherein the display controller displays, if the post-conversion image is displayed with a turn, the additional information so that the additional information keeps the display settings in the pre-conversion image.

13. The image processing apparatus according to claim 7, wherein the display controller displays, if the post-conversion image is displayed with a turn, the additional information so that the additional information keeps the display settings in the pre-conversion image.

14. The image processing apparatus according to claim 1,
wherein the storage stores depth information in association with the specified position in the pre-conversion image, and
wherein, if the depth information is changed at the post-conversion position, the display controller displays the additional information in the post-conversion image so that a size of the additional information is changed based on the changed depth information.

15. The image processing apparatus according to claim 2,
wherein the storage stores depth information in association with the specified position in the pre-conversion image, and
wherein, if the depth information is changed at the post-conversion position, the display controller displays the additional information in the post-conversion image so that a size of the additional information is changed based on the changed depth information.

16. The image processing apparatus according to claim 3,
wherein the storage stores depth information in association with the specified position in the pre-conversion image, and
wherein, if the depth information is changed at the post-conversion position, the display controller displays the additional information in the post-conversion image so that a size of the additional information is changed based on the changed depth information.

17. The image processing apparatus according to claim 4,
wherein the storage stores depth information in association with the specified position in the pre-conversion image, and
wherein, if the depth information is changed at the post-conversion position, the display controller displays the additional information in the post-conversion image so that a size of the additional information is changed based on the changed depth information.

18. The image processing apparatus according to claim 5,
wherein the storage stores depth information in association with the specified position in the pre-conversion image, and
wherein, if the depth information is changed at the post-conversion position, the display controller displays the additional information in the post-conversion image so that a size of the additional information is changed based on the changed depth information.

19. The image processing apparatus according to claim 6,
wherein the storage stores depth information in association with the specified position in the pre-conversion image, and
wherein, if the depth information is changed at the post-conversion position, the display controller displays the additional information in the post-conversion image so that a size of the additional information is changed based on the changed depth information.

20. A non-transitory computer readable medium storing a program causing a computer operating as an image processing apparatus to execute a process comprising:
specifying a position in a pre-conversion image;
storing the specified position in the pre-conversion image in association with additional information;
performing coordinate conversion for the pre-conversion image to obtain a post-conversion image in a different coordinate system, and performing coordinate conversion for the specified position in the pre-conversion image to obtain a post-conversion position in the different coordinate system; and
displaying the additional information at the post-conversion position serving as a reference position in the post-conversion image.
